(19) United States
(12) Patent Application Publication
(10) Pub. No.: US 2016/0017626 A1
(43) Pub. Date: Jan. 21, 2016

(54) WATCHTOWER

(71) Applicant: Global Owl Limited, Gibraltar (GI)

(72) Inventors: Gideon ARGAMAN, London (GB); Francis LE CARPENTIER, Puerto Banus (ES)

(21) Appl. No.: 14/380,045

(22) PCT Filed: Feb. 18, 2013
(86) PCT No.: PCT/GB2013/050380

§ 371 Date: Aug. 20, 2014

Related U.S. Application Data
(60) Provisional application No. 61/600,775, filed on Feb. 20, 2012.

(51) Int. Cl. E04H 9/06; F41H 5/20; E06B 5/10; E04H 12/34; E02D 27/32

(52) U.S. Cl. CPC E04H 9/06; E04H 12/342; E02D 27/32; E06B 5/106; F41H 5/20

(57) ABSTRACT

A watchtower (100) useable as a secure shelter for at least one observer is disclosed. The aforesaid watchtower (100) comprises (a) a base (130) placeable on the ground; (b) a body vertically erected onto the base; the body is formed by a plurality of substantially hollow members (110, 112) placed one upon the other; (c) an observer's compartment (120) crowning the body; and (d) means (115) for mechanically interconnecting said base, substantially hollow members (110, 112) and observer's compartment (120) therebetween. The means (115) is configured for releasably interconnecting the base (130), substantially hollow members (110, 112) and observer's compartment (120) therebetween such that the erected watchtower (100) is demountable in sections.

### FIELD OF THE INVENTION

The current invention relates to a watchtower useable as a secure shelter for at least one observer and, more specifically, to a watchtower provided with means for mechanically interconnecting in a releasable manner.

### BACKGROUND OF THE INVENTION

Watching over locations of interest is a matter of securing a specific zone or passage, and may be associated with dangerous or even deadly activities. Watchmen in their duty of surveillance or inspection over designated areas may be put into dangerous situations during their duty hours. The well-being of the watchmen is not only an interest of the watchmen themselves but also a matter of the quality of service provided by the personnel.

Explosions and blast can produce, in a very short time, an overload much greater than the design load of a building. Explosives or projectiles can cut or deform structural members with Chemical Energy or Kinetic Energy. In spite of this buildings can and do survive such effects without collapse, if correctly designed to do so. On the other hand structures which are not so designed can suffer rapid cumulative collapse, such as we have seen at Oklahoma City, the World Trade Centre, the Marine Base in Lebanon, Ronan Point, as well as countless collapses in Earthquake areas.

Cladding and glass can be detached and fly around, forming lethal weapons. Such debris is often the biggest cause of injury and death. Steps should be taken to maximize the distance from any attack using gates, barriers, chicanes and such like. Nothing can be guaranteed to eliminate all risks; but if the following design features were to be incorporated, many lives could be saved and many structures and businesses would survive.

Floors must be prevented from ‘falling off’ their supports. If pre-cast concrete planks are used they should have sufficient bearing; but they should not depend on bearing and gravity to stay in place: they should be made continuous with rebars between adjacent planks and preferably be made continuous with the supporting beams, using shear connectors. However a more robust detail is to pour continuous concrete slabs on to composite style decking which is itself continuous over 3 or so joists; such slabs should be poured so that they encapsulate the main beam to which the joists are fixed, and around the columns.

Joists should be made continuous themselves, through every main beam and wherever they coincide with outer columns. The joints should exceed the plastic capacity of the joists so that, if they fail, it is by plastic hinge and not by joint failure. Where joists are attached into the webs of outer beams no moment resistance is possible but there should be sufficient bolts to make shear failure unlikely before plastic hinges form in the outer main beam.

Main beams should be continuous across the structure and should have connections to the outer columns which exceed the plastic capacity of the main beam. This means that in the case of overload the beams deform, forming hinges, absorbing energy and taking time. Blast or shock loads will diminish in a very short time.

The main outer columns should remain elastic and strong enough to carry likely loads even when main beams attached to them form plastic hinges. Care should be taken that the shear capacity of the column should not be exceeded within the moment connection zone by the moment in the beam: this almost always requires haunched beam-to-column connections.

Very often the main beams will go through the internal columns, which will be bolted to the underside and top of the beams. These connections must be sufficiently strong to ensure full moment connection of the columns to the beams.

The ground to first floor columns carry the heaviest loads. They are always more vulnerable to attack. They are almost always longer than columns on other floors. They often have less stability because of gaps between them. And they often have no continuity below, as they sit on ‘pinned’ feet. So special care has to be taken: they need to be stronger; to have barriers to protect them; to have continuity at footings level with ground beams or slabs.

If all this continuity is achieved, even if a column or two are cut or deformed, the grillage of beams and joists and slabs at each floor throughout the building will continue to carry the loads. They may well deform substantially, joists and beams may well bend and form plastic hinges or act as a catenary net to share loads; but it would be exceptionally difficult to demolish such a building. To do so would require long study, and the placing of numerous cutting charges all over the structure, with a planned firing sequence; something very unlikely in the event of a conventional attack.

With industrial cladding the solution is to make all the cladding double spanning; then the centre rail is made strong and continuous, and the connections to the centre rail are made strong; whereas the rails either side of the centre rail are made weak (though still continuous) and the fixings weak. In the vent of a blast the cladding will fail at either end but remain fixed to the centre rail around which it will bend. The sheet will not fly around, and the sheet folding will reduce the forces on the structure.

With commercial buildings the same principle applies to the regular cladding. Windows should be kept modest in size. Windows should all be laminated. They should be in sturdy frames. But the frames should be fixed firmly to a strong rail, at the top; or at the bottom; or one side or the other; and less firmly to the other three edges. They will thus resist normal climatic loads and reasonable accidental loads, but will hinge inward from the strong edge before they burst and scatter glass.

If these cladding rules are applied there should be a much reduced scattering of flying shrapnel as a result of an attack.

US Patent Application 20090102743 ('743) discloses an antenna tower structure comprising an essentially vertical elongated tower body with an internal installation shaft provided therein. One or more radio base stations are arranged in the installation shaft in the vicinity of one or more associated antennas at the top of the tower body. The installation shaft is formed to allow personnel access to the radio base station. An elevator arrangement is also provided for an antenna tower structure.

U.S. Pat. No. 3,977,200 ('200) discloses a lighthouse or beacon construction configured for isolation from outer vibrations. The upper part of the construction is not in rigid connection with the lower part which is subject to forces which cause vibrations, and the construction is broken at a suitable height. The upper part is mounted on the lower part and it is supported by slide rails, roll rails, wheels, a flexible or pivoted parallelogram mechanism or elastic poles, or a corresponding flexible mechanism, such that the lower part can move substantially horizontally in relation to the upper part while the upper part is maintained in substantially vertical position.

The present-day world is prone to conflicts such as interethnic, interfaith, political and other sorts of conflicts. Many states are forced into confrontation with the threat of terror. Increasingly, the operational environment in the tactical theater changes from day to day, thus construction of permanent watchtowers do not always answer the ever changing terrorist threat. Thus, it is a long-felt and unmet need to provide a low cost watchtower which can be erected and demounted very quickly and with minimal labor inputs, both in terms of manpower and in terms of professional skills. Furthermore, there is a more specific long-felt and unmet need to provide a watchtower configured for effective protection of personnel and to reduce the incidence of injuries sustained during a survivable attack.

### SUMMARY OF THE INVENTION

It is hence one object of the invention to disclose a watchtower useable as a secure shelter for at least one observer. The aforesaid watchtower comprises: (a) a base placeable onto a ground; (b) a body vertically erected onto said base; said body formed by a plurality of substantially hollow members placed one upon the other; (c) an observer's compartment crowning said body; and (d) means for mechanically interconnecting said base, substantially hollow members and observer's compartment therebetween;

It is a core purpose of the invention to provide the means configured for releasably interconnecting said base, substantially hollow members and observer's compartment therebetween such that said erected watchtower is demountable.

Another object of the invention is to disclose the watchtower base which is displaceable along a surface of the ground as affected by a blast in the proximity to the watchtower. A further object of the invention is to disclose the mechanical interconnecting means comprising at least one substantially resilient element configured for damping vibrations between said hollow members as affected by a blast in the proximity to said watchtower. A further object of the invention is to disclose the interconnecting means which is a ring embracing butt joints between said substantially hollow members and said observer's compartment.

A further object of the invention is to disclose the a cross section of said hollow member selected from the group consisting a round cross section, a square cross section, an oval cross section, a polygon cross section and any combination thereof.

A further object of the invention is to disclose the watchtower observer's compartment shaped into a truncated inverted cone.

A further object of the invention is to disclose the observer's compartment provided with at least one bullet-proof window.

A further object of the invention is to disclose the observer's compartment provided with at least one window designed as at least two sash frames slidably displaceable relative to one another provide quick and easy opening of them at an instant of relevancy.

A further object of the invention is to disclose the watchtower designed for stability against direct hit of a projectile.

A further object of the invention is to disclose the observer's compartment further comprising a shock-absorbing mechanism configured for protecting an observer against lower limb joint trauma.

A further object of the invention is to disclose the shock-absorbing mechanism comprising a floor plate placed onto elastic absorbing pads.

A further object of the invention is to disclose the watchtower configured for circular defense.

A further object of the invention is to disclose the watchtower comprising at least one sliding firing opening (slit).

A further object of the invention is to disclose the base not anchored to the ground.

A further object of the invention is to disclose the mechanical interconnecting means not comprising any element providing rigid coupling of said hollow members therebetween.

A further object of the invention is to disclose the watchtower which meets requirement of MIL-HDBK-1013/1A.

A further object of the invention is to disclose the window configured at an angle θ to a direction of potential arrival of hollow charge missiles.

A further object of the invention is to disclose the window which is devoid of physical grillage, shielding or armour.

A further object of the invention is to disclose the watchtower meeting requirement of mark 4 to survivability for blast effects from explosive charges activated near the tower in window fragments and debris.

A further object of the invention is to disclose the watchtower meeting requirement of mark 5 to survivability for blast effects from explosive charges activated near the tower in structural debris.

A further object of the invention is to disclose the watchtower meeting requirement of mark 5 to survivability for blast effects from explosive charges activated near the tower in structural debris.

A further object of the invention is to disclose the watchtower meeting requirement of mark 5 to survivability for blast effects from explosive charges activated near the tower in blast pressures leakage into the structure.

A further object of the invention is to disclose the watchtower meeting requirement of mark 4 to survivability for blast effects from explosive charges activated near the tower in dynamic shock through the structure/floor.

A further object of the invention is to disclose the watchtower meeting requirement of mark 5 to survivability for fragmentation effects from projectiles/explosive devices activated near the tower in fragments penetration through windows.

A further object of the invention is to disclose the watchtower meeting requirement of mark 4 to survivability for fragmentation effects from projectiles/explosive devices activated near the tower in fragments penetration through walls.

A further object of the invention is to disclose the watchtower meeting requirement of mark 5 to survivability for survivability for shooting of small arms effects in bullets penetration through windows.

A further object of the invention is to disclose the watchtower meeting requirement of mark 5 to survivability for survivability for shooting of small arms effects in bullets penetration through walls.

A further object of the invention is to disclose the watchtower meeting requirement of mark 5 to survivability for direct hits of projectiles effects in direct hit on the roof.

A further object of the invention is to disclose the watchtower meeting requirement of mark 5 to survivability for direct hits of projectiles effects in direct hit on the walls.

A further object of the invention is to disclose the watchtower meeting requirement of mark 5 to survivability for blast effects from explosive charges activated near the tower.

A further object of the invention is to disclose the watchtower meeting requirement of mark 5 to survivability for fragmentation/shooting effects.

A further object of the invention is to disclose the watchtower meeting requirement of mark 4 to survivability for close-in/contact explosions of projectiles.

A further object of the invention is to disclose a method of erecting and demounting a watchtower. The aforesaid method comprises the steps of: (a) providing a watchtower further comprising:(i) a base placeable onto a ground; (ii) a body vertically erected onto said base; said body formed by a plurality of substantially hollow members placed one upon the other; (iii) an observer's compartment crowning said body; (iv) means for mechanically interconnecting said base, substantially hollow members and observer's compartment therebetween; (b) placing said base onto said ground at a location of interest; (c) vertically erecting said plurality of substantially hollow members placed one upon the other onto said base; (d) mounting said observer's compartment onto an upper butt if said body; (e) mechanically interconnecting said base, substantially hollow members and observer's compartment therebetween; (f) exploiting said watchtower; (g) demounting said watchtower; (h) conveying said watchtower to another location of interest; (i) cyclically repeating steps (b) to (h).

It is a still core purpose of the invention to provide the step of mechanically interconnecting said base, substantially hollow members and observer's compartment performed in a releasable manner.

A further object of the invention is to disclose the step of interconnecting butt joints between said substantially hollow members or said concrete ring and said observer's compartments performed by a member embracing said butt joints.

A further object of the invention is to disclose the step of protecting an observer performed by a shock-absorbing mechanism.

### BRIEF DESCRIPTION OF THE DRAWINGS

In order to understand the invention and to see how it may be implemented in practice, a plurality of embodiments is adapted to now be described, by way of non-limiting example only, with reference to the accompanying drawings, in which

FIG. 1 is a view of the watchtower appearance;

FIG. 2 is a cross-sectional view of the watchtower;

FIG. 3 is a schematic view of the hollow member interconnected therebetween;

FIG. 4 is a schematic view of the slidable watchtower;

FIGS. 5 and 6 are schematic views of fighting platform; and

FIG. 7 is a schematic view of the window frame;

### DETAILED DESCRIPTION OF THE INVENTION

The following description is provided, so as to enable any person skilled in the art to make use of said invention and sets forth the best modes contemplated by the inventor of carrying out this invention. Various modifications, however, are adapted to remain apparent to those skilled in the art, since the generic principles of the present invention have been defined specifically to provide a watchtower and a method of erecting and demounting the same.

The present invention discloses a fortified watchtower with novel and inventive features, combining the protection and fighting platform of a tank or turret like structure with the visual capabilities of a static watchtower or observation unit.

The core of the invention includes:

Rapid deployment

Rapid assembly and disassembly

Sliding base

Disconnected sections

Very high blast resistance to weight ratio

Specific protection against knee injuries for the occupant(s)

360 degrees field of vision

Grillage and armour free bullet proof windows

Unique battle platform

Compliance with MIL-HDBK-1013/1A (Military Handbook Design Guidelines for Physical Security of Facilities).

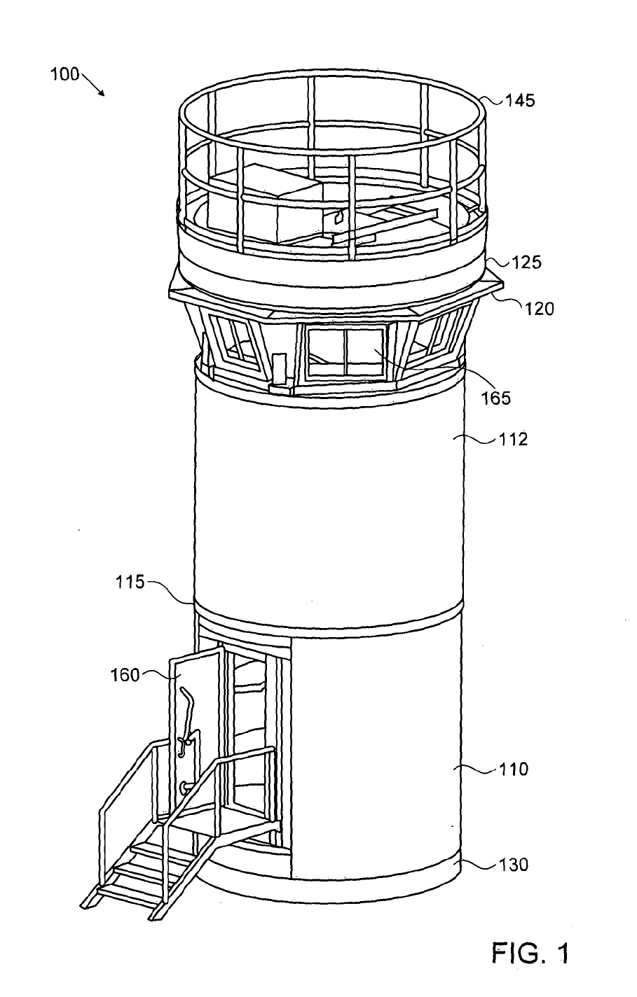

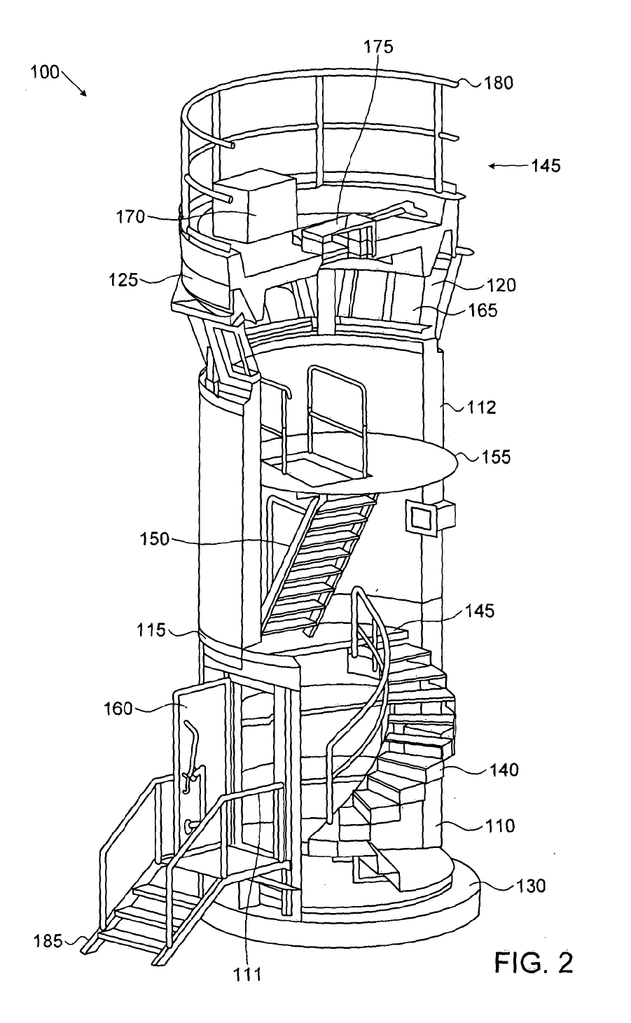

The term “watchtower” hereinafter refers to a type of fortification. The main functionality of the watchtower is to provide a high and safe place from which a sentinel, a guard, a soldier or another dedicated personnel may observe the surrounding area. Reference is now made to FIGS. 1 and 2, presenting a watchtower 100 which is configured for quickly erecting and demounting so that it can then be redeployed at another location when required. The watchtower 100 comprises a base 130; a plurality of substantially hollow members (concrete rings) 110 (for example, preformed sewage pipes) placed one upon the other mounted on a base 130, an observer's section 120 and a cover 125 which covers the observer's section 120 from above. A number of the hollow members can be changed in accordance with a required height of the watchtower 100. The concrete rings are interconnected by means of demountable fixating rings 115. The section 120 accommodating a compartment for observers can be configured into a truncated cone. The window frame 120 is provided with bullet-proof windows 165. The aforesaid windows 165 designed as at least two sash frames slidably displaceable relative to one another provide quick and easy opening of them at an instant of relevancy. In accordance with the preferred embodiment of the current invention, an angle between the window 165 and hollow member 112 is about 120°. An armored door 160 is designed for reliable protection of observers from intruders. A specific feature of the door 160 is an option of unlocking of the locked door by improvised means without a key, whilst access is concealed from without. Stairs 185 serve for convenience of the users. Inside the hollow member 110, there beds or cots 111 can be placed for off duty observers. Optionally, stretchers for emergency evacuation of the observers or storage racks (not shown) can be placed there as well. A work place of the observers (not shown) is on a platform 155. The observers step up stairs 140 and 150 through a platform 145. The window frame 120 is covered with a member 125 with an escape port 175. The aforesaid escape port 175 is provided with a suspended telescopic ladder (not shown). The watchtower 100 can be equipped with a protective barrier 180, an air conditioning system 170, a searchlight and a remotely controlled machine gun (not shown). The watchtower 100 optionally has at least one embrasure 119 for shooting with small-arms. The watchtower 100 provides reliable protection of the observers. In case of external hazards or an enemy attack, personnel within the watchtower 100 are able to observe and respond throughout 360° angle.

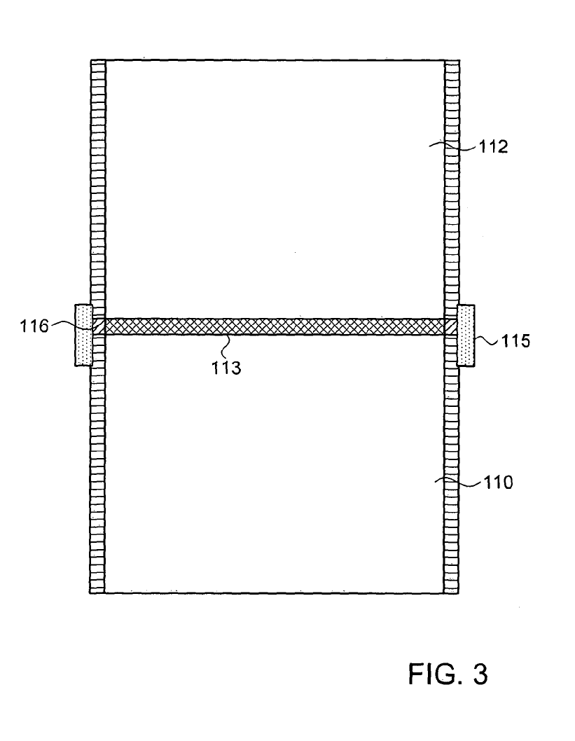

Reference is now made to FIG. 3, presenting the hollow member 110 and the hollow member 112 placed atop the member 110. The member 112 is provided with a ring 115 for limiting transverse displacement. An elastic spacer 116 is designed for shock energy absorption of explosion in proximity of the watchtower. Non-rigid interconnection of the hollow members 110 and 112 provides more stability against hostile acts.

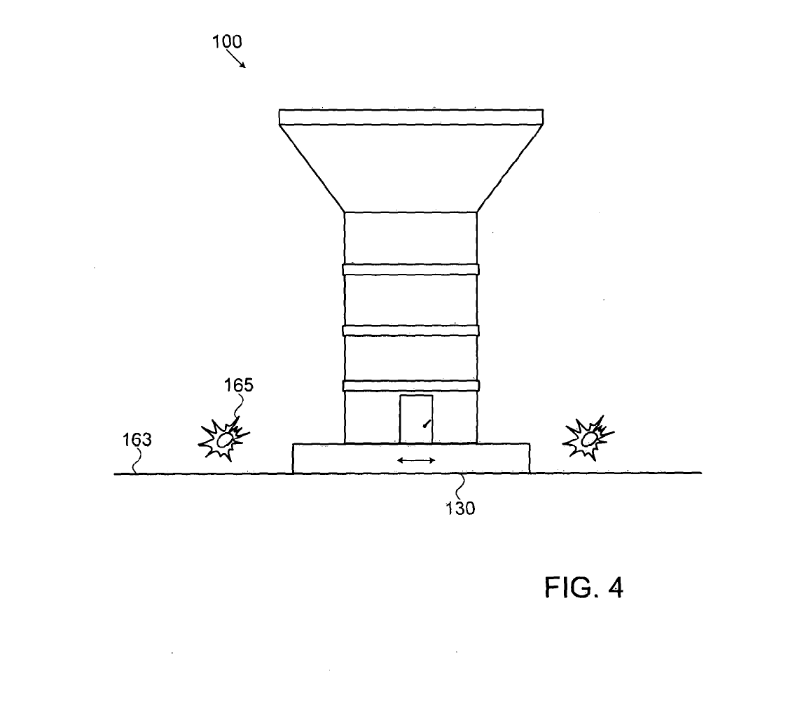

Reference is now made to FIG. 4, illustrating another key feature of the current invention. The base 130 of the watchtower 100 is placed on a ground surface 163 such that the base 130 can slide (be displaced) over the surface 463 as affected by a explosion 165. Thus, the energy of the explosion 165 applied to the watchtower 100 is partially expended for a displacement of the watchtower 100 along the ground surface 165 and destructive effect of the explosion decreases.

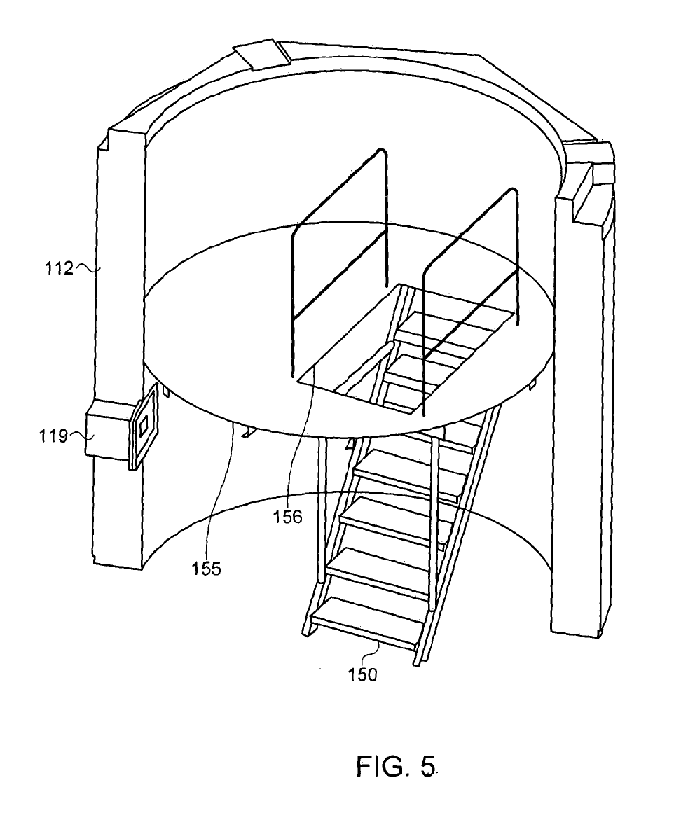

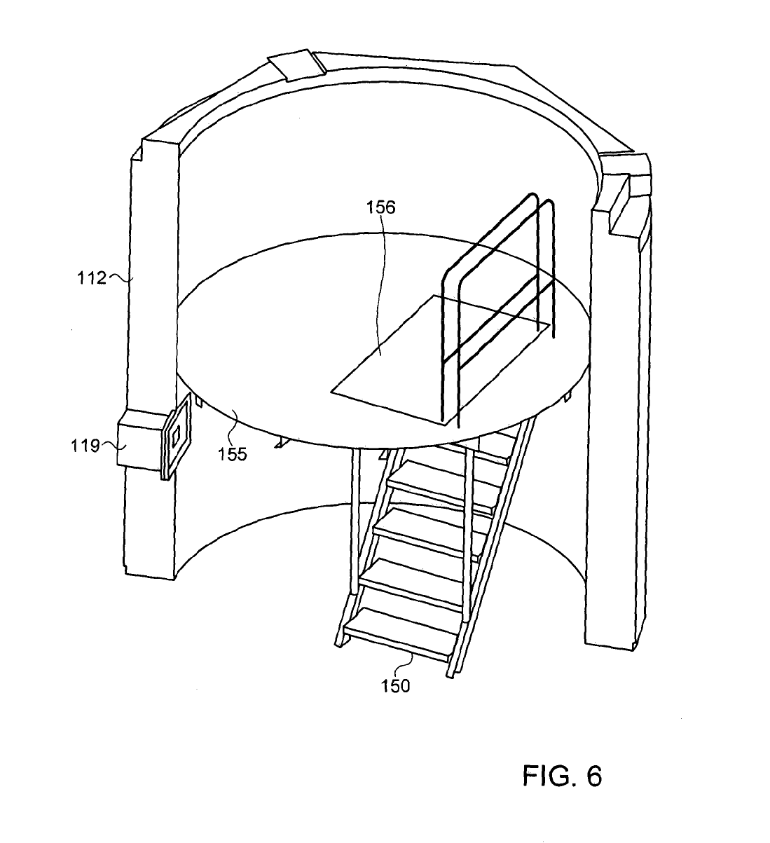

Reference is now made to FIGS. 5 and 6, presenting a fighting platform 155. The aforesaid platform 155 is provided with a sliding hatch 156 such that the fighting platform has a smooth surface when the hatch 156 is closed (FIG. 6). The hatch 156 is lockable from the inside in order to prevent intrusion.

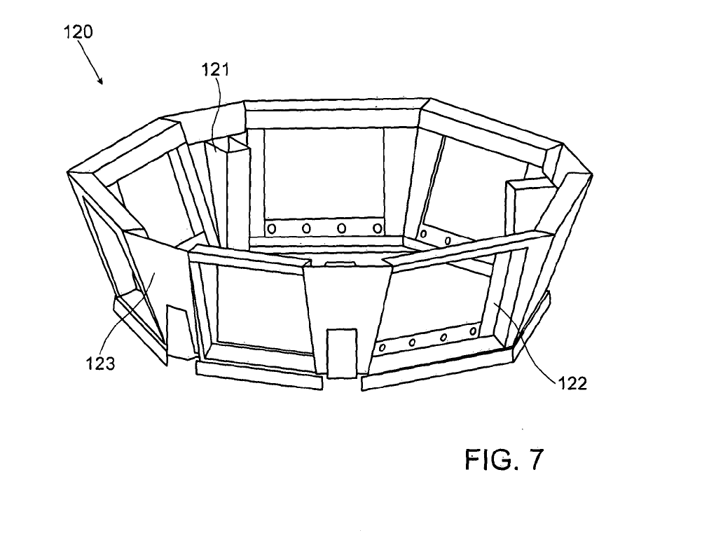

Reference is now made to FIG. 7, presenting a window frame 120 comprising window cases 122 for mounting windows 165 (not shown) thereinto and steel plates 123 reinforced by square bars 121.

The observation compartment is equipped with at least one suspended seat. The aforesaid seat is suspended from a circular rail secured to a ceiling of the compartment. The seat can be shifted along the circular rail.

The survivability parameters of the soldiers on the top observation level for various types of attacks in the various towers are experimentally determined. The summary table of performance levels, marked with values from 1 to 5, is presented.

TABLE
SURVIVABILITY/PROTECTIVE HARDENING

| | | | Steel | Concrete | |
|---|---|---|---|---|---|
| Survivability parameter | | | tower | tower | Invention |
| SD | SDB | SDB1 | 3 | 3 | 4 |
| | | SDB2 | 4 | 3 | 5 |
| | | SDB3 | 3 | 3 | 5 |
| | | SDB4 | 1 | 3 | 5 |
| | SDF | SDF1 | 3 | 3 | 4 |
| | | SDF2 | 4 | 3 | 5 |
| | SDS | SDS1 | 3 | 3 | 4 |
| | | SDS2 | 4 | 3 | 5 |
| | SDH | SDH1 | 2 | 2 | 5 |
| | | SDH2 | 4 | 3 | 5 |

| | | | | |
|---|---|---|---|---|
| SIND | SINDB | 1 | 3 | 5 |
| | SINDF | 1 | 3 | 5 |
| | SINDH | 1 | 3 | 5 |

| | | | |
|---|---|---|---|
| Average performance level mark | 2.62 | 2.92 | 4.77 |

Explanatory Notes:

The steel tower protective hardening characteristics are:
a. top observation post with steel walls and roof
b. blast resistant windows on the observation level.

The concrete tower main protective hardening characteristics are:
a. reinforced concrete walls and roof
b. blast resistant windows on the observation level
c. entrance blast door

Embodiments of the present invention score more highly for the following reasons, explained topic by topic:

1. Survivability from Effects of Direct Attacks

1.1 Survivability for Blast Effects from Explosive Charges Activated Near the Tower—SDB

1.1.1 Windows Fragments and Debris—SDB1

The reason for the higher mark for the invention is that the windows are optimally angled to reduce the hazard of fragments and debris.

1.1.2 Structural Debris—SDB2

Intrinsic to the core of the invention:

The higher mark of the invention as compared to the steel tower is due to the cylindrical shape of the walls which withstands blast better than the rectangular planar walls.

1.1.3 Blast Pressures Leakage into the Structure—SDB3

Windows orientation (120°) reduces significantly the possibility of their breakage thus preventing blast leakage.

1.1.4 Dynamic Shock through the Structure/Floor—SDB4

In prior art, the observation level floor is totally exposed to the blast wave and therefore the dynamic shock on the soldiers will be maximal. The higher mark for the invention is because the observation floor is supported by shock-absorbing devices reducing substantially the shock hazard.

2. Survivability for Fragmentation Effects from Projectiles/Explosive Devices Activated Near the Tower—SDF

2.1 Fragments Penetration through Windows—SDF1

The reason for the higher mark for the invention is that the windows are emplaced with an optimal angle reducing the hazard of fragments penetration.

2.2 Fragments Penetration through Walls—SDF2

The reason for the higher marks for the steel tower and invention is that the walls made of steel have a reduced hazard of fragments penetration as compared to the concrete walls of the concrete tower—where spalling of the concrete may occur. The higher mark of the invention as compared to the steel tower is due to the cylindrical shape of the walls which is better in allowing fragmentation penetration than the rectangular planar walls.

3. Survivability for Shooting of Small Arms Effects—SDS

3.1 Bullets Penetration through Windows—SDS 1

The reason for the higher mark for the invention is that the windows are emplaced with an optimal angle (120°) reducing the hazard of fragments penetration.

3.2 Bullets Penetration through Walls—SDS2

The reason for the higher marks for the steel tower and invention is that the walls made of steel have a reduced hazard of bullets penetration as compared to the concrete walls of the concrete tower—where spalling of the concrete may occur. The higher mark of the invention as compared to the steel tower is due to the cylindrical shape of the walls which is better in allowing bullets penetration than the rectangular planar walls.

4. Survivability for Direct Hits of Projectiles Effects—SDH 4.1 Direct Hit on the Roof—SDH1

The reason for the higher marks for the invention is that the observation level roof is specially designed—with high-strength concrete and steel fibers—to withstand the effects of indirect hits of projectiles.

4.2 Direct Hit on the Walls—SDH2

The reason for the higher marks for the steel tower and invention is that the walls made of steel have a reduced hazard of contact explosion effects as compared to the concrete walls of the concrete tower—where spalling of the concrete may occur. The higher mark of the invention as compared to the steel tower is due to the cylindrical shape of the walls which is better in withstanding the effects of contact explosion than the rectangular planar walls.

5. Survivability for Indirect Attacks Effects

5.1 Survivability for Blast Effects from Explosive Charges Activated Near the Tower—SINDB

The reason for the lowest mark for the steel tower is that the supporting elements are totally exposed and vulnerable to the blast effects, may be severely damaged and may induce the tower collapse. The higher mark of the invention as compared to the concrete tower is due to the cylindrical shape of the walls which is better in withstanding the blast effects than the rectangular planar walls.

5.2 Survivability for Fragmentation/Shooting Effects—SINDF

The reason for the lowest mark for the steel tower is that the supporting elements are totally exposed and vulnerable to the fragmentation/shooting effects, and may be severely damaged. Tower collapse may be induced. The higher mark of the invention as compared to the concrete tower is due to the cylindrical shape of the walls which is better in withstanding the fragmentation/shooting effects than the rectangular planar walls.

5.3 Survivability for Close-In/Contact Explosions of Projectiles—SINDH

The reason for the lowest mark for the steel tower is that the supporting elements are totally exposed and vulnerable to the close-in/contact explosions of projectiles effects, and may be severely damaged. Tower collapse may be induced. The higher mark of the invention as compared to the concrete tower is due to the cylindrical shape of the walls which is better in withstanding the close-in/contact explosions of projectiles effects than the rectangular planar walls.

The obtained experimental data indicate that the watchtower of the current invention has obvious advantages over referent steel and concrete towers.

The watchtower provides safe performance as defined by of US General Services Administration.

The watchtower meets requirement of MIL-HDBK-1013/1A (MILITARY HANDBOOK DESIGN GUIDELINES FOR PHYSICAL SECURITY OF FACILITIES).

1-54. (canceled)

55. A watchtower useable as a secure shelter for at least one observer; said watchtower comprising:
(a) a base placeable onto a ground;
(b) a body vertically erected onto said base; said body formed by a plurality of substantially hollow members placed one upon the other;
(c) an observer's compartment crowning said body;
(d) means for mechanically interconnecting said base, hollow members and observer's compartment therebetween;
said means are configured for releasably interconnecting said base, hollow members and observer's compartment therebetween such that said erected watchtower is demountable;
wherein said watchtower base is displaceable along a surface of said ground by blast in the proximity to said watchtower.

56. The watchtower according to claim 55, wherein said mechanical interconnecting means comprises at least one substantially resilient element configured for damping blast generated vibrations between said hollow members affected by a blast in the proximity to said watchtower.

57. The watchtower according to claim 55, wherein said interconnecting means is a member embracing butt joints between said substantially hollow members and said observer's compartment.

58. The watchtower according to claim 55, wherein a cross section of said hollow member is selected from the group consisting a round cross section, a square cross section, an oval cross section, a polygon cross section and any combination thereof.

59. The watchtower according to claim 55, wherein said observer's compartment is shaped into a truncated inverted cone.

60. The watchtower according to claim 59 wherein said observer's compartment is configured for substantially 360 degrees field of vision and operation.

61. The watchtower according to claim 59, wherein said observer's compartment is provided with at least one bullet-proof window.

62. The watchtower according to claim 59, wherein said observer's compartment is provided with at least one window designed as at least two sash frames slidably displaceable relative to one another provide quick and easy opening of them at an instant of relevancy.

63. The watchtower according to claim 55 designed for stability against direct hit of a projectile.

64. The watchtower according to claim 59, wherein said observer's compartment further comprises a shock-absorbing mechanism configured for protecting an observer against lower limb joint trauma.

65. The watchtower according to claim 64, wherein said shock-absorbing mechanism comprises a floor plate placed onto elastic absorbing pads.

66. The watchtower according to claim 55 configured for circular defense.

67. The watchtower according to claim 55, wherein said base is not substantially anchored to the ground.

68. The watchtower according to claim 55, wherein said mechanical interconnecting means does not comprise any element providing rigid coupling of said hollow members therebetween.

69. A method of erecting, exploiting and demounting a watchtower; said method comprising the steps of:
(a) providing a watchtower further comprising:
i. a base placeable onto a ground;
ii. a body vertically erected onto said base; said body formed by a plurality of substantially hollow members placed one upon the other;
iii. an observer's compartment crowning said body;
iv. means for mechanically interconnecting said base, substantially hollow members and observer's compartment therebetween;
(b) placing said base onto said ground at a location of interest;
(c) vertically erecting said plurality of substantially hollow members placed one upon the other onto said base;
(d) mounting said observer's compartment onto an upper butt if said body;
(e) mechanically interconnecting said base, substantially hollow members and observer's compartment therebetween;
(f) exploiting said watchtower;
(g) demounting said watchtower;
(h) conveying said watchtower to another location of interest;
(i) cyclically repeating steps (b) to (h);
said step of mechanically interconnecting said base, substantially hollow members and observer's compartment is performed in a releasable manner;
wherein said method comprises a step of displacing said watchtower base along a surface of said ground as affected by a blast in the proximity to said watchtower.

70. The method according to claim 69, further comprising a step of displacing said watchtower base along a surface of said ground as affected by a blast in the proximity to said watchtower.

71. The method according to claim 69, further comprising a step of damping inter-vibrations between said hollow members as affected by a blast in the proximity to said watchtower by means of mechanical interconnecting means which comprises at least one substantially resilient element

72. The method according to claim 69, wherein said step of interconnecting butt joints between said substantially hollow members and said observer's compartment is performed by a member embracing said butt joints.

73. The method according to claims 69, wherein said observer's compartment is shaped into a truncated inverted cone.

74. The method according to claim 69, wherein said observer's compartment is provided with at least one bullet-proof window.
